(19) United States
(12) Patent Application Publication
(10) Pub. No.: US 2005/0153052 A1
(43) Pub. Date: Jul. 14, 2005

(54) Food and beverage quality sensor

(75) Inventors: John R. Williams, Lexington, MA (US); Kathleen E. Myers, Medford, MA (US); Megan M. Owens, Somerville, MA (US); J. Ryan Prince, Marlborough, MA (US)

Correspondence Address: GOODWIN PROCTER LLP;PATENT ADMINISTRATOR, 53 STATE PLACE, BOSTON, MA, 02109-2881, US

(73) Assignee: The Charles Stark Draper Laboratory, Inc., Cambridge, MA (US)

(21) Appl. No.: 10/756,724

(22) Filed: Jan. 13, 2004

(51) Int. Cl. A23L 1/20

(52) U.S. Cl. 426/634

(57) ABSTRACT

A method and device for sensing food quality includes a detection material having an inherent sensitivity to a contaminant and changing a property in response thereto. The detection material is subjected to a modulating agent to alter the sensitivity of the detection material, so that exposure of the detection material to the contaminant causes the property to change in response to a level corresponding to the altered detection sensitivity.

### FIELD OF THE INVENTION

The invention relates generally to food and beverage sensors, and more particularly to a method and device for monitoring the quality of food or beverage using a calorimetric, potentiometric, or resistive detection material.

### BACKGROUND OF THE INVENTION

Monitoring the quality of perishable food is a critical task throughout the food production, storage, distribution, and consumption chain. Many food products are subject to spoilage, either as a result of improper handling or simply due to aging. If a perishable product such as milk or meat is exposed to excessive temperatures during transit, for example, it will age and spoil prematurely, but ultimately spoilage is inevitable. Today, food distributors typically apply expiration dates to their products, but these dates essentially represent an estimate—that is, they assume an average (or even perfect) “heat history” that corresponds to a known aging profile. Except on a spot basis, food distributors generally do not continuously monitor the quality of their products.

Spoiled food not only poses risk due to illness, but also represents lost revenue for grocers and squandered wages for the consumer. Many devices for monitoring the quality of food do not provide a quick, simple, and effective diagnostic because they either use harmful substances as the indicator of spoilage or utilize a generic indicator that is not “tuned” to the food being detected. For example, chemical indicators of spoilage are naturally present in certain foods; levels that would indicate spoilage in some foods may be perfectly consistent with freshness in other foods.

Accordingly, there exists a need for spoilage detectors offering a rapid response that may be tuned for variations in foods and contaminants.

### SUMMARY OF THE INVENTION

The invention, in one aspect, provides a low-cost, mass-producible sensor that reliably reports the presence of chemicals and/or bacteria in food and beverages due to spoilage or contamination. As used hereinafter, the term “food” relates to both food and beverages. In one embodiment, the sensitivity of the detection material of the sensor is tuned to the point of onset of a property change indicative of a threshold contaminant concentration. The sensor thereby facilitates specificity with respect to different food products and contaminants, as the sensitivity may be tuned based on these parameters.

Tuning permits faster and more reliable detection, since an inspector need not wait an extended period of time for the detection material to exhibit a property change. If a rapid response is not observed, then the food is deemed to be of suitable quality. In addition, tuning permits faster detection, allowing the inspector to inspect more food in a shorter period of time. The detection material may be a natural and/or edible substance as well, which eliminates the possibility of contamination of unspoiled food with a harmful chemical or dye.

In one aspect, therefore, the invention provides a sensor including a detection material having a property that changes in response to exposure to a contaminant. The detection material has an inherent sensitivity to the contaminant governing changes in the property in response thereto. The sensor also includes a modulating agent in an amount sufficient to cause the detection material to exhibit an altered sensitivity different from the inherent sensitivity. In one embodiment, the altered sensitivity is greater than the inherent sensitivity. Alternatively, the altered sensitivity may be less than the inherent sensitivity. In various embodiments, the contaminant includes an amine. In some embodiments, the detection material includes beet or cabbage extract. The modulating agent may be a base (e.g., hydroxide, bicarbonate, lysine, arginine, and histidine).

In various embodiments, the property that changes is color or an electrical property (e.g., a potential difference or resistance). In some embodiments, the detection material is disposed within a matrix (e.g., filter paper). The detection material may include a detection threshold that is dependent on type of food being screened; for example, the amount of modulating agent used may be dependent on the nature of the food and/or the contaminant being detected. In one embodiment, the altered sensitivity corresponds to a user-selectable detection threshold.

In one embodiment of the sensor, the detection material has a resistive property that varies in response to a rate of decomposition of food to which the detection material is exposed, and the sensor also includes a second detection material having a potentiometric property that varies in response to freshness of the food. In an alternative embodiment, the detection material has a resistive property that varies in response to a level of contamination in food to which the detection material is exposed, and the sensor also includes a second detection material having a potentiometric property that varies in response to a rate of decomposition of the food. In another embodiment, a detector in accordance with the invention includes a series of differently tuned dyes, each with a different detection threshold, in order to indicate a degree of freshness rather than a binary indication that the food is either fresh or spoiled.

In another aspect, the invention provides a method of sensing a contaminant. The method includes providing a detection material disposed in a medium. The detection material has an inherent sensitivity to a contaminant and a property that changes in response thereto in accordance with the inherent sensitivity. The detection material is subjected to a modulating agent to alter the sensitivity of the detection material. Exposing the detection material to a contaminant changes the property in response to a level of the contaminant corresponding to the altered detection sensitivity. In one embodiment, the modulating agent enhances the sensitivity of the detection material by causing it to approach a point of onset of an exposure-induced property change. In some embodiments, the modulating agent reduces the sensitivity of the detection material, while in other embodiments, it enhances sensitivity.

In yet another aspect, the invention provides a sensor including a detection material having a property that changes in response to exposure to a contaminant. The detection material has an inherent sensitivity to the contaminant governing changes in the property in response thereto. The sensor also includes a display reporting a food condition based on a response of the detection material indicating a level of the contaminant and a user-selectable reporting threshold. In various embodiments, the user-selectable reporting threshold is dependent on type of food being screened, on the contaminant, or on a personal tolerance level.

In still another aspect, the invention provides a method of sensing a food condition. The method includes providing a detection material having an inherent sensitivity to a contaminant and a property that changes in response thereto in accordance with the inherent sensitivity. The detection material is exposed to the contaminant such that the property changes in response to exposure to the contaminant, and a food condition is reported based on the property change and a user-selectable reporting threshold.

Other aspects and advantages of the invention will become apparent from the following drawings, detailed description, and claims, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. In the drawings, like reference characters generally refer to the same parts throughout the different views. The drawings are not necessarily to scale, emphasis instead generally being placed upon illustrating the principles of the invention.

FIG. 1 is a block diagram of an illustrative embodiment of a sensor according to the invention.

FIG. 2 shows a titration curve for a typical calorimetric detection material.

FIG. 3 is a block diagram of an illustrative embodiment of detection device including a sensor according to the invention.

FIGS. 4A and 4B show bottom-up and top-down, exploded views, respectively, of an exemplary embodiment of a detection device including a sensor according to the invention.

FIG. 5 is a perspective, sectional view of the detection device of FIG. 4 packaged as a bottle cap.

FIG. 6 shows an exemplary handheld detection device including a sensor according to the invention.

FIG. 7 is a perspective, sectional view of a colorimetric indicator including a sensor according to the invention.

FIG. 8 is an exemplary flow diagram for an electronic system based on a detection device of the invention.

FIG. 9 shows an exemplary resistive bridge.

### DETAILED DESCRIPTION OF THE INVENTION

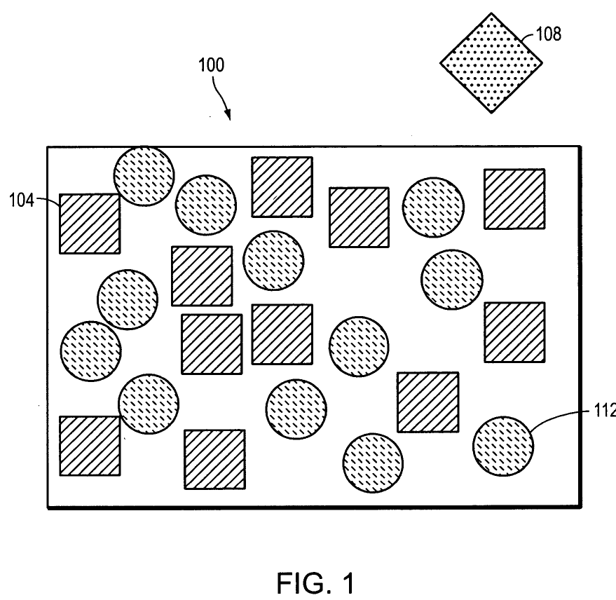

With respect to FIG. 1, a sensor 100 according to the invention includes a detection material 104 that has an inherent sensitivity to a contaminant 108, i.e., exposure of the detection material to a threshold concentration of the contaminant 108 causes a property of the detection material to undergo a change. To alter this inherent sensitivity—that is, to render the detection material 104 more or less sensitive to the contaminant 108—the detection material 104 is exposed to a modulating agent 112.

For example, to enhance the inherent sensitivity, the detection material 104 may be exposed to (e.g., titrated with) a sufficient amount of the modulating agent 112 to cause the detection material to approach a point of onset of the property change. In this way, even a small concentration of the contaminant 108 will cause the detection material 104 to undergo the property change and thereby indicate the presence of the contaminant 108. Alternatively, the modulating agent may reduce the inherent sensitivity, e.g., by competitively binding to the detection material 104 in a manner that does not cause the change in property, or by sequestering or inactivating some portion of the contaminant 108. The sensitivity may be lowered using the methods described below to optimize the sensor so that it does not change color when the food has not spoiled.

A sensor may be used to detect contaminants in foods such as milk, water, wine, beef, poultry, seafood, and grains, as well as other perishable foods. The contaminant may be a spoilage product. In addition, the contaminant may be an amine, i.e., a compound bearing one or more NH₂ groups (e.g., an amine, diamine, triamine, aromatic amine, heterocyclic amine, or aliphatic amine). For example, proteins are generated from amino acids; when proteins are bacterially decomposed, they are converted to amines related to these amino acids. The amino acid arginine is converted to putrescine, lysine to cadaverine, and histidine to histamine. Putrescine, cadaverine and histamine are responsible for the smell of rotting protein such as meat and seafood, and the levels of these amines reflect the degree of bacterial decomposition. Accordingly, a detector sensitive to amine compounds can be used to indicate spoilage.

A sensor may be incorporated into a milk bottle, a bottle cap, a wine stopper, plastic wrap, styrofoam, a plastic bag, a paper bag, cardboard, or other suitable packaging for food. The sensor may also be incorporated into a cooler or an appliance, such as a handheld kitchen appliance. In an alternative embodiment, a cartridge including the sensor is placed into a cabinet, a drawer, or a refrigerator. Specific embodiments of sensors are described in more detail below.

The property that changes in response to exposure to the contaminant may be a calorimetric property, a potentiometric property, or a resistive property. Detection materials include, but are not limited to, natural acid-base indicators such as those present in beets, cabbage, red wine, grapes, tea, blueberries, strawberries, and cranberries. Other suitable acid-base indicators that may be used as the detection material include, but are not limited to, crystal violet, cresol red, thymol blue, bromophenol blue, methyl orange, bromcresol green, methyl red, eriochrome black, bromcresol purple, bromthymol blue, phenol red, phenolphthalein, thymolphthalein, and mordant orange. Other suitable detection materials include stearic acid, amine ionophores, polymeric indicators, and hydrocarbons, such as linear or branched C₃₂H₆₆. A preferred detection material exhibiting a colorimetric change in response to the presence of amines is beet extract or juice. More generally, the detection material may be a betalain or a betalain derivative. Betalains suitable for use in connection with the present invention are red-violet betacyanins, and useful compounds include betanidin, betanin and their derivatives (e.g., esters of betanin).

Suitable acid-base modulating agents include, but are not limited to, bicarbonates and their salts, carbonates and their salts, hydroxides (e.g., NaOH, KOH, and LiOH), ammonia and ammonium salts, biogenic amines and their salts, amines and their salts, amino acids and their salts, carboxylic acids and their salts, phosphoric acid and its salts, sulfuric acid and its salts, and boric acid and its salts Preferably, the modulating agent is a base (e.g., hydroxide, bicarbonate, lysine, arginine, histidine, and triethanolamine). Preferably, the base is bicarbonate.

The sensitivity of the colorimetric sensors may be altered by the use of co-pigments, concentration, combining indicators, surface area, and illumination. For a resistive sensor, the sensitivity can be altered by modifying ratios of conductor to indicator, starting value of resistance, surface area, size, conductor choice, and indicator choice. In one embodiment of the sensor, the detection material is disposed or sequestered within a matrix, e.g., a physical matrix such as filter paper or a polymer matrix. The modulating agent also may be sequestered with the detection material. The matrix may be hydrophobic. A hydrophobic matrix prevents water from accessing the materials sequestered within the matrix, such as the detection material and/or the modulating agent, while permitting the contaminant to pass through and interact with the detection material. As a result, the hydrophobic nature preserves the useful life of the detection material. In various embodiments, the detection material and modulating agent combination is applied to a cloth, such as cheese cloth, to paper, or to a surface of a plastic. Alternatively, the detection material and modulating agent combination may be disposed within a gel or gelatin.

In the embodiments described above, the detection material may be first disposed/applied to the matrix, gel, cloth, paper, or surface prior to exposure to the modulating agent; In some embodiments, the detection material and the modulating agent are first mixed, and then disposed or applied.

To alter the sensitivity of detection materials whose activities are affected by pH, the pH at which a color change occurs for a particular detection material first is determined. Then a fresh solution is titrated with a modulating agent to form a tuned solution of the detection material with a pH that is slightly lower (e.g., for a basic contaminant) or higher (e.g., for an acid contaminant) than that needed for a color change to occur. The matrix is then soaked in the tuned solution and dried. The tuned sensor is now sensitive to a small amount of contaminant, such that exposure will cause a color change on a time scale shorter than the response time scale of an untuned sensor. For amine-based contaminants and betalain detection chemistries, bicarbonate has been found to be a suitable modulator.

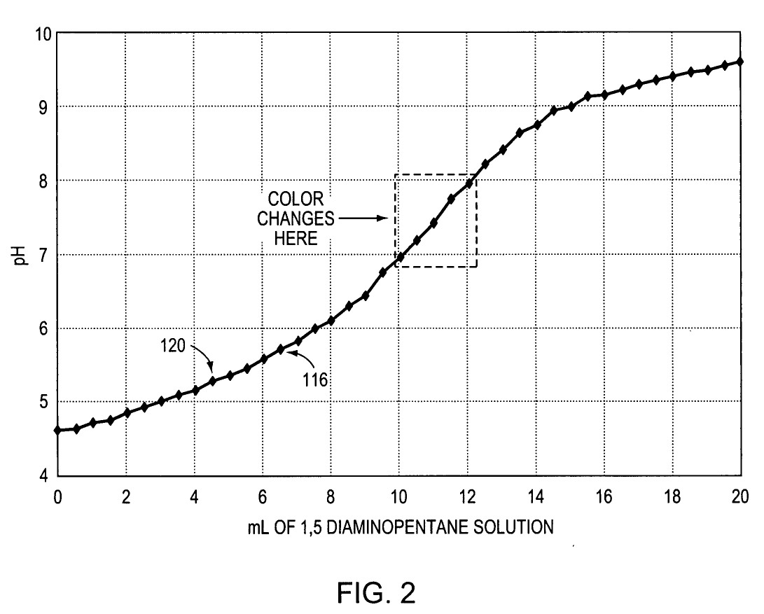

Referring to the titration curve shown in FIG. 2, an exemplary tuned sensor based on beet extract (primarily betanin) may have a starting pH of about 6.5 (as indicated at 116), which is tuned from about a pH of 4.6 (as indicated at 120). In FIG. 2, the exemplary modulating agent is a solution of 1,5-diaminopentane. Therefore, less contaminant is required to effect the color change, which occurs at a pH above 6.5 and which may be observed visually or by using, for example, a color densitometer or a spectrometer. In FIG. 2, the difference between the two pH values 116, 120 represents the altered sensitivity of the detection material. Starting pH's larger than 6.5, which more closely approach the point of onset of color change of beet extract, may also be used.

To prepare the solution whose response is shown in FIG. 2 in immobilized form on ordinary filter paper, the amount of a base required to effect a color change is calculated based on reaction stoichiometry, and an aqueous solution of modulating agent is prepared with slightly less than the calculated amount of modulating agent. The filter paper is first dipped in the aqueous modulating agent solution and dried. Then the filter paper is dipped in a non-aqueous detection material solution. The filter paper is now tuned for detection of low levels of amines. In an alternative embodiment, the first solution may be non-aqueous, and the second solution aqueous.

In another embodiment, the indicator and modulator solutions are prepared using the same solvent and tuned to a pH slightly before that which effects a color change. The filter paper is then dipped in the solution and used to detect low levels of contaminant.

To tune the solution for immobilization on filter paper, the detection material solution itself is titrated so that it has slightly less than the amount of modulating agent needed to effect a color change. The filter paper may be Phase Separation (PS) filter paper, available from Whatman, Inc. (Clifton, N.J.). The PS filter paper is dipped in the tuned solution and dried for use as a colorimetric detector of biogenic amines. A detector in accordance with the invention may be based on a single length of filter paper that includes a series of segments each corresponding to a differently tuned dye, each with a different detection threshold. This may provide a more striking visual indication of contaminant level, as the contrast between affected and unaffected dye segments will be apparent. This approach may also be used to indicate a degree of freshness rather than a binary indication that the food is either fresh or spoiled.

For example, untuned beet extract has a pH of about 4.6. Exposing the filter paper impregnated with beet extract to a saturated headspace of 1,5-diaminopentane (cadaverine) requires about 4 days for a color change to occur. However, by tuning the beet extract to a pH between about 7.00 and 8.02, a rapid color change on the order of about 15 seconds is observed. Using a natural or edible substance like beet extract (or a component thereof, e.g., betanin) also eliminates the potential of spoiling or contaminating food with the detection material.

By proper selection of the detection material and the modulating agent, a sensor may be formed with an altered sensitivity that corresponds to a detection threshold that is dependent on the type of food being screened. For example, different detection materials or different amounts of modulating agent may be selected based on the contaminant expected to be detected and/or the character of the food (e.g., the natural presence of some amines even in fresh seafood). This permits rapid and meaningful detection of the contaminant of interest. Furthermore, the altered sensitivity of the sensor may be selected to correspond to a user-selectable detection threshold, which permits a user to adjust the sensitivity to one's personal tolerance level for a particular contaminant or state of freshness of a food product.

For example, according to FDA guidelines, fish with greater than 50 ppm of histamine is considered spoiled. Therefore, depending on one's personal tolerance, a detection threshold of, for example, 30 ppm, 40 ppm or 50 ppm may be set. Detection of the contaminant occurs at this threshold level. In contrast, shrimp are considered spoiled at a concentration of 3 ppm of putrescine or cadaverine. Therefore, a different detection material/modulating agent combination may be selected to detect these contaminants. The selection of the material/agent combination may be based on the contaminant, the food, or on the tolerance level for the contaminant.

An alternative to chemical detection materials are ion-selective electrodes, which may be used to detect contaminants based on a potentiometric property. Suitable ion-selective electrodes may be fabricated using materials and techniques described, for example, in U.S. patent application Ser. No. 10/388,198, filed Mar. 13, 2003, commonly owned with the instant application and herein incorporated by reference in its entirety. Briefly, a pair of electrodes is designed to develop an electrical potential when in the presence of a contaminant of interest. The cathode is rendered specific to this contaminant by coating with a semi-permeable ionophore. The anode, or reference electrode, is coated with a non-ion specific ionophore.

An ion-selective electrode of the invention may be selected to detect pH (i.e., H+), Na⁺, K⁺, Li⁺, Ag⁺, Ca²⁺, Cd²⁺, Ba²⁺, Mg²⁺, Cu²⁺, Pb²⁺, Hg²⁺, Cu²⁺, Fe³⁺, ammonium ions (NH₄⁺), Cl⁻, Br⁻, I⁻, F⁻, CN⁻, OCl⁻, perchlorate (ClO₄⁻), thiocyanate (SCN⁻), sulphide (S⁻), nitrate (NO₃⁻), nitrite (NO₂⁻), sulfate (SO₃⁻), carbonate (CO₃⁻), bicarbonate (HCO₃⁻), and/or S₂O₃²⁻. For amine detection, an ionophore such as Calix[6]arene-hexaacetic acid hexaethylester, available from Sigma-Aldrich Co. (St. Louis, Mo.), is preferred. The ion-selective electrodes may be utilized to detect ions by, for example, amperometric, potentiometric, coulombic, conductometric and/or AC analysis techniques as are well-known to those skilled in the art.

Another approach utilizes sensors having a detection material with a resistive property. For example, the detection material may be an imprinted polymer or an organic coating including a conductive material. In one embodiment, carbon black polymer resistors, or a polymer imprinted with carbon black, is employed. [See Lonergran et al., “Array-Based Vapor Sensing Using Chemically Sensitive, Carbon Black-Polymer Resistors,” Chemistry of Materials 8: 2298-2312 (1996), the entire disclosure of which is herein incorporated by reference.] Alternatively, thin films of carbon and a detection material, such as those described above, are deposited across two metallic leads attached to an insulate substrate, thereby forming a resistor. Suitable insulative substrates include, but are not limited to, ceramic and plastic substrates. Swelling of the detection material due to exposure to a vapor cause the resistance of the resistor to increase because the carbon connecting the leads separates as the detection material swells. A change in resistance therefore signals that a swell-inducing vapor is present.

Sensors formed in accordance with the present invention therefore are chosen so as to be responsive to a contaminant indicative of a spoiled food. In one embodiment, sensors are imprinted with detection materials including the natural acid-base indicators and the other suitable acid-base indicators listed above, which have resistive properties. An ionophore, such as those described above, may also be used. In one version of the acid-base indicators, the resistive sensor functions as a dosimeter.

In one embodiment, a solution including a conductor and a detection material is deposited on a substrate with electrical leads. For example, 25 mg of carbon powder may be combined with 75 mg of stearic acid, and dissolved and/or suspended in 20 ml of tetrahydrofuran (THF). The solution is sprayed, e.g., as an aerosol, onto a ceramic substrate with electrical leads. Alternatively, the solution may be poured onto an array of substrates or onto a large substrate, and then divided into individual substrates. The THF evaporates to leave a thin film of conductor and detection material across the electrical leads. Other materials, including gold, silver, and copper, may also be used as the conductor. Typically, the thin film has a resistance of about 100 kΩ prior to exposure to the contaminant.

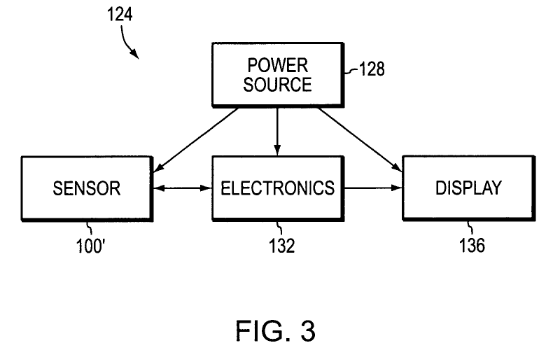

FIG. 3 depicts a detection device 124 including a sensor 100′ according to the invention. The detection device 124 also includes a power source 128, electronic circuitry 132, and a display 136. The sensor 100′, or an element thereof, may be disposable or reusable, and the detection device 124 itself may be disposable as well. Exemplary detection devices 124 are described in more detail below.

The sensor 100′ may include a detection material with a potentiometric property, such as amine ionophore, or a resistive property, such as carbon black combined with beet extract, as described above. In alternative embodiments, a detection device or sensor includes a plurality of detection materials. For example, the sensor 100′ may include a first detection material having a resistive property and a second detection material having a potentiometric property. The resistive sensor may have an integrative response to an accumulation of contaminant such that the output is proportional to rate of decomposition of food. The potentiometric sensor may respond to the concentration of the contaminant at a given point in time, so the output is proportional to the current state of freshness of the food. In another embodiment, the detection material has a resistive property that varies in response to a level of contamination in food to which the detection material is exposed, and the second detection material has a potentiometric property that varies in response to a rate of decomposition of the food. This redundant approach not only mitigates risk, but also permits an inspector to predict the if/when the food may spoil, if it has not already.

In one embodiment of a detection device or sensor with multiple detection materials, each input signal from its respective detection material is converted to a digital signal prior to processing. For example, if 50 ppm of an amine is the threshold for meat being spoiled or contaminated and the test result is 40 ppm, the display first outputs that the meat is still good. If that information is coupled with a measurement indicating that the meat is producing amines at a rate of 10 ppm per day, the display also outputs that the meat has one day left before it is spoiled.

As described above, the sensitivity of the detection material may be altered by titration, so that they are more responsive to a contaminant of interest. The range of sensitivity of the detection material may also be controlled. Because the quantity of a contaminant indicative of spoilage may vary among different foods, the range of resistivity may be altered, so that they the sensor is effectively calibrated to the food and the contaminant.

The power source 128 may be a battery (e.g., alkaline, lithium ion, rechargeable, or printed paper). Ideally, the battery is flexible, and conforms to the shape of the packaging of the detector. Power Paper Ltd. (Tel Aviv, Israel) manufactures one suitable printed paper battery. The chemicals used in Power Paper's battery are a combination of zinc and manganese dioxide. The battery may be printed using silkscreen technology onto almost any surface, including paper or flexible plastic. A one-square-inch printed battery provides 1.5 V for 15 mAh, is about 0.5 mm thick, and has a shelf life of up to about 2½ years.

The electronics 132 may be formed on a circuit board, for example, as an application-specific integrated circuit (ASIC). The functions performed by the electronics 132 include amplification of signal, calibration of the detection device, and providing a logic system for the decision making process. Exemplary electronic systems include a CMOS chip capable of reading one type of sensor (e.g., a resistive sensor or a potentiometric sensor) at a set sensitivity level (albeit altered or unaltered). In an alternative embodiment, the CMOS chip may have a variable sensitivity that can be controlled by the inspector. The chip may also be coupled to multiple sensors. Exemplary electronic circuits will be described in more detail below.

The sensor 100′ may be microfabricated on the same microchip as the electronics 132 using CMOS technology, instead of using separate microfabrication processes (i.e., one for the ion-sensor cartridge and one for the electrical circuit). This not only reduces the cost, but also conserves chip “real estate” since some connections between the sensor and the electronics may be shortened or eliminated.

The display 136 presents the decision of the electronics 132 to the inspector by reporting a food condition based on a response of the detection material of the sensor. The display 136 may report the food condition based on a user-selectable reporting threshold. For example, the threshold level may be determined by the type of food being screened, by the contaminant of interest, or by a personal tolerance level. The detection device 124 may include a switch (not shown) that permits the user to select a threshold level at which spoilage of food is reported.

In various embodiments, the display is coupled to a switch that permits the user to select the type of food information to be reported. For example, the state of freshness of the food, the rate at which the food is spoiling, the level of a contaminant, and/or a prediction of the remaining shelf life of the food are suitable options.

The display 136 may be as simple as the color change associated with the detection material, or in other embodiments, may be provided by printable electrochromic ink or a digital display (e.g., a liquid crystal display). The display 136 may include a plurality of indicators driven by the electronics 136 described above. The power requirement of the indicator is desirably within the capacity of the battery and the driving power of the controlling electronics 132. The display 136 is preferably flexible, durable, and inexpensive.

A suitable electrochromic ink is a NANOCHROMICS display, available from Ntera Ltd. (Dublin, Ireland). The display changes color in response to an electric potential. The diameter of the particles of the electrochromic ink is about 5 nm to about 20 nm, and therefore they can be printed using a conventional ink-jet printer. The display can change state in 0.1 seconds. The ink is either clear or white in its off-state and upon the application of 1.2 V turns blue, green, or black depending on the specific ink. The display holds its state until an opposite potential is applied. Because this type of ink that can be printed onto plastic or paper, it can be made flexible and conformable. To change state, 3 mC of charge is required for each square centimeter of display. The display can be under the control of digital electronics, which issues a trigger signal when spoilage is determined, or an analog signal from a detector can be processed (e.g., amplified) such that a detector output corresponding to spoilage causes electrochromic transition, but an output below this level does not.

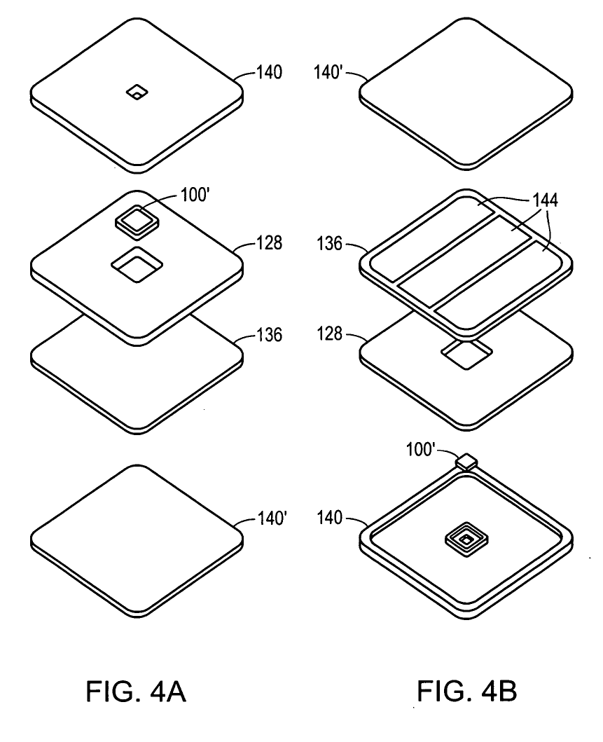

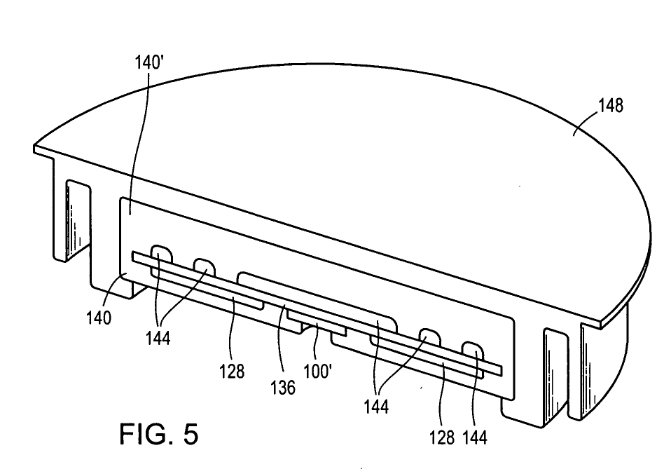

With reference to FIGS. 4A and 4B, an exemplary embodiment of a detection device 124′ includes bottom 140 and top 140′ portions of a transparent or translucent encapsulent material that encapsulates the sensor 100′, the printed battery power source 128, and the electrochromic ink display 136. The display 136 includes three indicator portions 144 on a top surface of the display 136, which may, for example, indicate a good, marginal, and spoiled result. The indicators 144 of the display 136 are preferably visible through the top portion 140′ of the encapsulent material. FIG. 5 depicts an illustrative embodiment of the detection device 124′ packaged as a cap 148 for a bottle (e.g., a bottle for milk).

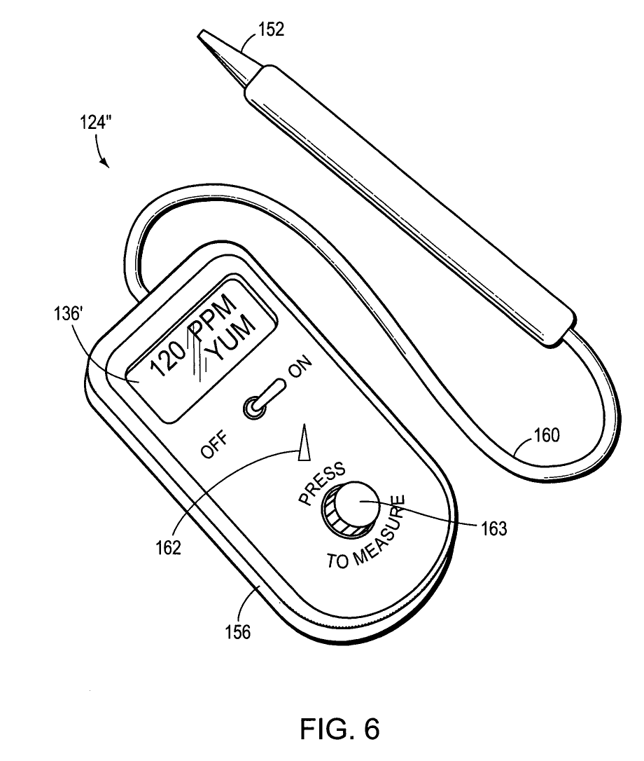

FIG. 6 depicts a handheld detection device 124″ with a probe 152 connected to a body 156 by a cord 160. A sensor 100′ using a potentiometric or resistive property of the detection material is included in the probe 152. The power source 128 and electronics 132 (not shown) are housed within the body 156 of the detection device 124″. The detection device 124″ also includes a digital display 136′, which is coupled to a switch 162. In one embodiment, the switch 162 is used to set the user-selectable reporting threshold, as described above. The detection device 124″ also includes a reset button 163 that is pressed to initiate a measurement.

The digital display may, for example, show the level of the contaminant, e.g., as a scale from 1 to 100. This reading may also be a measure of the freshness or spoilage of the food, as described above. To perform a reading, a baseline value is determined and displayed in parentheses in the display. Periodically, the resistance or potential of the detection material is measured and displayed. If the resistance or potential exceeds a predetermined detection threshold (which may correspond to the inherent sensitivity of the detection material or a modified sensitivity), then the display indicates that the food is spoiled or that a contaminant is present. For example, the display may indicate “YUM” for food that has not spoiled, and “YUCK” for food that has a threshold contaminant level corresponding to spoilage, or may simply use a numerical readout. In other embodiments, the display options include a series of LEDs or an analog gauge. As described above, the detection threshold need not be fixed, and may depend on the contaminant being detected or the food being monitored. For example, the sensor may be dialed to the food of interest (i.e., meet, fish, poultry, milk, etc.), which results in alteration of the threshold.

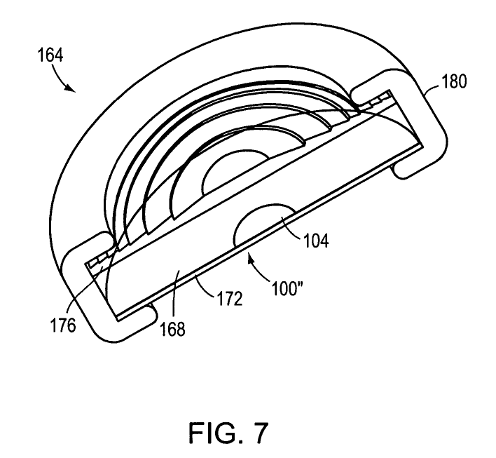

FIG. 7 shows an illustrative embodiment of a calorimetric indicator 164 including a sensor 100″ according to the invention. The calorimetric indicator 164 indicator, which has the appearance of a cartridge, does not require a power source, electronics, and display, although an embodiment may be formed with such elements as described above. The indicator 164 is disposable, and may be used for detecting contaminants in a cabinet, a drawer, a refrigerator, a bag, or other container.

The sensor 100″ includes a detection material 104 with a colorimetric property. The detection material 104 may be treated with a modulating agent 112 (not shown), as described above. In addition, the detection material 104 may be disposed within a matrix 168, such as filter paper. A contaminant accesses the detection material 104 via a semi-permeable membrane 172. The indicator also may include a magnification device 176 (e.g., a Fresnel lens as shown) for easier viewing of the detection material 104, although the indicator may be formed without the magnification device as well. The elements of the indicator 164 are held together using an encapsulating material 180 (e.g., a retaining ring). The sensor 100″ may include (e.g., be surrounded by) a color scale ranging from the detector color corresponding to ideal freshness to the color corresponding to unambiguous spoilage.

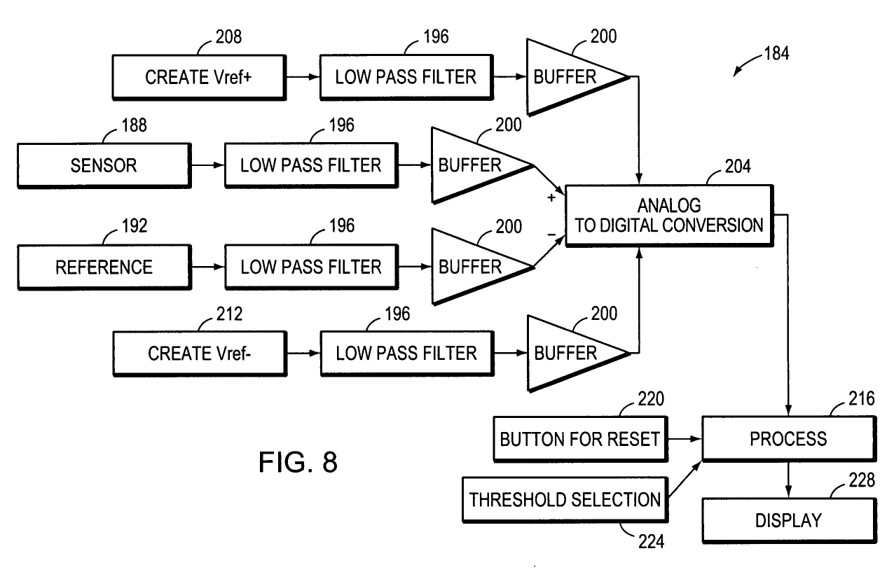

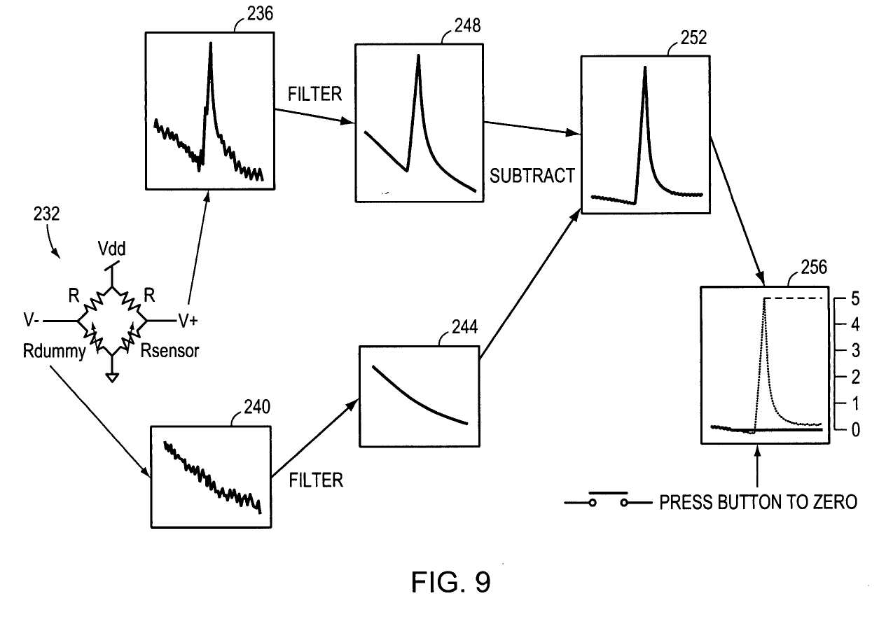

FIG. 8 depicts a flow diagram for an exemplary electronic circuit 184 of a detection device. For an embodiment using a potentiometric sensor, the sensor 188 is an ion-selective electrode, preferably selective for an amine, and the reference 192 sensor is a reference electrode. For an embodiment using a resistive sensor, the sensor 188 is a resistive sensor, as described above, and the electronics may include a dummy sensor (reference 192). The resistive sensor and the dummy sensor may be formed as a resistive bridge (see FIG. 9) such that a potential develops across the bridge in relation to the value of the resistance. The signals from the sensor and the reference are filtered by low pass filters 196 and may be buffered 200 and/or amplified as well.

The output of the sensor 188 and the reference 192 may be displayed on an analog display. Alternatively, the outputs of the sensor 188 and the reference 192 may be converted to a digital signal using an analog to digital (A/D) conversion 204. In various embodiments, the electronics of either the resistive sensor embodiment or the potentiometric sensor embodiment may include reference voltages. For example, the sensor 188 may use Vref+ 208, and the reference 192 may use Vref− 212. The reference voltages improve the resolution of a measurement by changing the step-size of A/D conversion 204. For example, if Vref− and Vref+ are about 0 V and about 5 V respectively, then the step size of a 10 bit A/D converter is about 4.88 mV. Changing the reference voltages to between about 1 V and 3 V would change the A/D step size to about 1.95 mV. The reference voltages may be filtered 196 and buffered 200 as well.

In one embodiment, the electronics includes a processor 216 for managing the circuit. The electronics may include a reset button 220 that shuts the power off to the processor, thereby resetting the baseline, prior to making a new measurement. The electronics may include a button or switch for threshold selection 224, as described in detail above. In various embodiments, a display 228 such as a LCD or other similar display is used to output the result.

A resistive bridge 232, and representations of its output signals, are shown in FIG. 9. The resistive sensor (Rsensor) is paired with a dummy resistor (Rdummy), where the resistive sensor is exposed to food and the dummy resistor is protected from vapors. Box 236 shows a typical signal that results when a contaminant is detected, while box 240 shows the baseline signal of the dummy sensor isolated from the contaminant. The filtered signal 244 is subtracted from the filtered signal 248 to cancel environmental effects (e.g., temperature or other background noise). The differential signal 252 is then used for analysis of the food. Box 256 shows the signal after resetting.

While the invention has been particularly shown and described with reference to specific illustrative embodiments, it should be understood that various changes in form and detail may be made without departing from the spirit and scope of the invention as defined by the appended claims.

1. A sensor comprising:
a detection material having a property that changes in response to exposure to a contaminant, the detection material having an inherent sensitivity to the contaminant governing changes in the property in response thereto; and
a modulating agent in an amount sufficient to cause the detection material to exhibit an altered sensitivity different from the inherent sensitivity.

2. The sensor of claim 1 wherein the altered sensitivity is greater than the inherent sensitivity.

3. The sensor of claim 1 wherein the altered sensitivity is less than the inherent sensitivity.

4. The sensor of claim 1 wherein the contaminant comprises an amine.

5. The sensor of claim 1 wherein the detection material comprises beet or cabbage extract.

6. The sensor of claim 1 wherein the modulating agent comprises a base.

7. The sensor of claim 6 wherein the base comprises at least one of the group consisting of hydroxide, bicarbonate, lysine, arginine, and histidine.

8. The sensor of claim 1 wherein the property comprises color.

9. The sensor of claim 1 wherein the property comprises an electrical property.

10. The sensor of claim 9 wherein the electrical property comprises an amperometric, coulombic, resistive or potentiometric property.

11. The sensor of claim 1 wherein the detection material is disposed within a matrix.

12. The sensor of claim 1 wherein the altered sensitivity corresponds to a detection threshold that is dependent on type of food being screened.

13. The sensor of claim 1 wherein the altered sensitivity corresponds to a user selectable detection threshold.

14. The sensor of claim 1 wherein the amount of the modulating agent used is dependent on the contaminant being detected.

15. The sensor of claim 1 wherein the detection material has a resistive property that varies in response to a rate of decomposition of food to which the detection material is exposed, and further comprising a second detection material having a potentiometric property that varies in response to freshness of the food.

16. The sensor of claim 1 wherein the detection material has a resistive property that varies in response to a level of contamination in food to which the detection material is exposed, and further comprising a second detection material having a potentiometric property that varies in response to a rate of decomposition of the food.

17. A method of sensing a contaminant, the method comprising:
providing a detection material disposed in a medium, the detection material having an inherent sensitivity to a contaminant and a property that changes in response thereto in accordance with the inherent sensitivity;
subjecting the detection material to a modulating agent to alter the sensitivity of the detection material; and
exposing the detection material to the contaminant such that the property changes in response to exposure to the contaminant in accordance with the altered detection sensitivity.

18. The method of claim 17 wherein the property comprises color.

19. The method of claim 17 wherein the property comprises an electrical property.

20. The method of claim 19 wherein the electrical property comprises an amperometric, coulombic, resistive or potentiometric property.

21. The method of claim 17 wherein the modulating agent enhances the sensitivity of the detection material by causing the detection material to approach a point of onset of an exposure-induced property change.

22. The method of claim 17 wherein the modulating agent reduces the sensitivity of the detection material.

23. The method of claim 17, wherein the contaminant comprises an amine.

24. The method of claim 17, wherein the detection material comprises beet or cabbage extract.

25. The method of claim 17, wherein the modulating agent comprises a base.

26. The method of claim 25, wherein the base comprises at least one of the group consisting of hydroxide, bicarbonate, lysine, arginine, and histidine.

27. The method of claim 17 wherein the altered sensitivity corresponds to a detection threshold that is dependent on type of food being screened.

28. The method of claim 17 wherein the altered sensitivity corresponds to a user selectable detection threshold.

29. The method of claim 17 wherein the detection material has a resistive property that varies in response to a rate of decomposition of food to which the detection material is exposed, and further comprising providing a second detection material having a potentiometric property that varies in response to state of freshness of the food.

30. The method of claim 17 wherein the detection material has a resistive property that varies in response to a level of decomposition of food to which the detection material is exposed, and further comprising providing a second detection material having a potentiometric property that varies in response to a rate of decomposition of the food.

31. A detection device comprising:
a detection material having a property that changes in response to exposure to a contaminant, the detection material having an inherent sensitivity to the contaminant governing changes in the property in response thereto; and
a display reporting a food condition based on a response of the detection material indicating a level of the contaminant and a user-selectable reporting threshold.

32. The detection device of claim 31, wherein the user-selectable reporting threshold is dependent on type of food being screened.

33. The detection device of claim 31, wherein the user-selectable reporting threshold is dependent on the contaminant.

34. The detection device of claim 31, wherein the user selectable reporting threshold is dependent on a personal tolerance level.

35. The detection device of claim 31 wherein the contaminant comprises amine.

36. The detection device of claim 31 wherein the property comprises color.

37. The detection device of claim 31 wherein the property comprises an electrical property.

38. The detection device of claim 37 wherein the electrical property comprises an amperometric, coulombic, resistive or potentiometric property.

39. The detection device of claim 31 wherein the detection material has a resistive property that varies in response to a rate of decomposition of food to which the detection material is exposed, and further comprising a second detection material having a potentiometric property that varies in response to a state of freshness of the food.

40. The detection device of claim 31 wherein the detection material comprises a resistive property that varies in response to a level of decomposition of food to which the detection material is exposed, and further comprising a second detection material having a potentiometric property that varies in response to a rate of decomposition of the food.

41. A method of sensing a food condition, the method comprising:
providing a detection material having an inherent sensitivity to a contaminant and a property that changes in response thereto in accordance with the inherent sensitivity;
exposing the detection material to the contaminant such that the property changes in response to exposure to the contaminant; and
reporting a food condition based on the property change and a user-selectable reporting threshold.

42. The method of claim 41, wherein the user-selectable reporting threshold is dependent on type of food being screened.

43. The method of claim 41, wherein the user-selectable reporting threshold is dependent on the contaminant.

44. The method of claim 41, wherein the user-selectable reporting threshold is dependent on a personal tolerance level.

45. The method of claim 41 wherein the contaminant comprises amine.

46. The method of claim 41 wherein the property comprises color.

47. The method of claim 41 wherein the property comprises an electrical property.

48. The method of claim 47 wherein the electrical property comprises an amperometric, coulombic, resistive or potentiometric property.

49. The method of claim 41 wherein the detection material has a resistive property that varies in response to a rate of decomposition of food to which the detection material is exposed, and further comprising providing a second detection material having a potentiometric property that varies in response to a state of freshness of the food.

50. The method of claim 41 wherein the detection material has a resistive property that varies in response to a level of decomposition of food to which the detection material is exposed, and further comprising providing a second detection material having a potentiometric property that varies in response to a rate of decomposition of the food.
